(19) United States
(12) Patent Application Publication
(10) Pub. No.: US 2022/0395772 A1
(43) Pub. Date: Dec. 15, 2022

(54) EMBER BLOCKING VENT SCREEN AND METHOD OF INSTALLATION

(71) Applicant: Stephen Rosa, Reno, NV (US)

(72) Inventor: Stephen Rosa, Reno, NV (US)

(21) Appl. No.: 17/834,234

(22) Filed: Jun. 7, 2022

Related U.S. Application Data
(60) Provisional application No. 63/209,679, filed on Jun. 11, 2021.

(51) Int. Cl. B01D 46/00; B01D 46/10; B01D 39/10

(52) U.S. Cl. CPC B01D 46/0005; B01D 46/0001; B01D 46/103; B01D 39/10; B01D 2265/04; B01D 2279/35; B01D 2239/1216

(57) ABSTRACT

An ember-blocking vent screen for covering a roof vent comprises a screen section and at least two strips of pressure sensitive adhesive (PSA) heavy duty tape attached at opposite edges of the screen section such that deployment portions of the tape strips overlap and extend transversely beyond their respective screen edges. The screen section is made of stainless steel or aluminum wire, has interstices sufficiently small to block passage of small minimum diameter embers therethrough, is lightweight, and is sufficiently malleable to be capable of conforming to the contour of the vent being covered. The deployment portion of the tape strips is such that deployment portions of the tape extend transversely (i.e., widthwise) beyond respective screen edges covered with a release liner that is removable for installation of the screen

### CROSS REFERENCE TO RELATED APPLICATIONS

This application is a non-provisional application claiming priority from U.S. Provisional Application No. 63/209,679, entitled “Ember Blocking Vent Screen and Method of Installation”, and filed Jun. 11, 2021, the disclosure in which is incorporated in its entirety herein by this reference.

### TECHNICAL FIELD

The disclosure generally relates to an emergency response solution to prevent embers resulting from wildfires from penetrating building vents, and more specifically to a screen structure and its installation method for effecting that solution.

### BACKGROUND OF THE DISCLOSURE

Wind-blown embers are the principal cause of building ignitions during wildfires. Recent fire seasons in California and many other states in the US west and in southwestern Australia have seen some of the most devastating wildfires in history. The damage and destruction done include lives lost and billions of dollars in property damage. These events have caused government agencies to address the problem of embers (also called “brands,” or “firebrands”) created during these events that are carried by winds and enter the attics, eaves and other sections of structures even miles away from a fire itself. The result frequently is that the structure catches fire and the disaster spreads. Experts opine that once a fire has spread to the attic of a typical home, that structure is a total loss.

Building codes and standards that apply to new construction and existing buildings have specific requirements for attic and sub-floor (crawl space) vents. Examples of these may be seen in US20080220714 (Caruso et al) and US20090286463 (Daniels), the entire disclosures in which are incorporated herein by reference. The practical challenge, however, is that many structures built in the wildland-urban interface (WUI) prior to adoption of these updated building codes do not include means to address the ember issue; retrofitting these structures with code-acceptable solutions requires trained contractors installing expensive and often custom fabricated gratings and barriers.

Building and homeowners recognize the need to address the ember problem, but the backlog for this work, in California for example, is measured in years. Additionally, the owners of many structures such as mobile homes cannot afford the cost of these installations and, as a result, many such owners dither on applying a solution with the mindset that “it won't happen to me.” Unfortunately, when wildfires arise and it appears that it is about to “happen here”, many home and building owners need a quick fix solution. Accordingly, there is a significant need for a rapid-to-install, low-cost ember barrier that building/home owners can independently and safely apply to their structure in the face of a wildfire threat.

The need for an ember-defeating solution that homeowners can rapidly deploy is well recognized. For example, the Insurance Institute For Business and Home Safety has recommended that, depending on the ease of accessing vents, a building owner could prepare vent covers (e.g., using ⅜ to ½ inch plywood and a thin metal plate) and include their installation as part of a wildfire pre-evacuation preparedness plan. Duct or metal tape could also be used as a last-minute vent covering effort. The recommendation goes on to state that these measures would be particularly useful for vents on vertical surfaces (gable end, foundation, and blocking in open-eave construction) since these types of vents and vent locations have shown to be vulnerable to embers. Of course, the covering would have to be removed after the wildfire threat has passed. This use of metal or duct tape to cover soffit and gable vents in the face of a fire was cited by the California state fire marshal as a last-ditch effort. However, cognizant home insurance companies pushed back on this idea, citing the problem of cutting off air circulation to attics and basements. In other words, installing air-blocking tape might defeat the possibility of embers entering the spaces, but it would cause growth of mold, bacteria and other long term and equally costly problems if not quickly removed after the fire danger has passed. Unfortunately, quick removal depends on the unreliable diligence of building owners for removing the tape after the wildfire threat had passed. Thus, a significant gap exists between what insurance companies and governments say is needed and what many building and homeowners can afford and support. The present disclosure presents a solution that fills this gap and meets all effectiveness and safety requirements.

Some prior art ember blocking vent cover systems, either for new construction or retrofit, include metal screens or meshes maintained in a flat planar configuration by a metal frame and installed over a vent with screws or nails. Examples are disclosed in US20140182864 (de St. Jeor et al.), US2016/0146499 (Sherry) and U.S. Pat. No. 9,011,221 (Daniels), the disclosures in which are incorporated by reference herein in their entireties. Such flat screen members that are held in place by a rigid frame cannot conform to irregular surfaces and therefore will not suffice as a retrofit cover for many irregularly shaped attic vents such as ridge, soffit and gable vent configurations already in place. This requirement eliminates inflexible mesh systems such as those found in the product line of Vulcan Technologies, Inc.

Additionally, research has shown that not all screens will meet the requirements described above. For example, plastic screens are not acceptable, and while the National Fire Protection Association (NFPA) Standard 1144 (2013) specifies a minimum ¼-inch (6 mm) noncombustible mesh screen covering for vents, it has been found that ember size is a variable dependent on many factors, such as the type of fuel (e.g., the type of tree or other vegetation) from which the embers result, and many embers are sufficiently small to pass through common ¼ inch screens. Recent testing and evaluation by California state fire officials revealed that many embers are smaller than ⅛ inch in minimum “diameter” and carry enough thermal energy to ignite dust and other dry, flammable materials typically found in residential and commercial attics and similar spaces.

As a further consideration, care must be given in selecting the means for attaching stainless steel or aluminum screen material over an existing roof or gable vent. Stapling or nailing a section of screen is potentially problematic since any sagging or separation occurring between the staples/nails would present an opening at the screen edge that wind-blown embers could pass through. Further, non-reinforced edges can readily separate and tear away from nails and staples when stressed by high wind conditions such as those typically experienced during wildfire episodes. In addition, in view of the urgency associated with approaching wildfires, any product solution must permit even home and building owners who lack efficient handyman aptitude to quickly and easily install the product.

### SUMMARY

This Summary is provided to introduce a selection of concepts in a simplified form that are more specifically described below in the Detailed Description. This Summary is not intended to identify key features or essential features of the claimed subject matter, nor is it intended as an aid in determining the scope of the claimed subject matter.

An article of manufacture is disclosed which addresses the problems described above by providing a lightweight metal ember-blocking screen with high strength tape strips pre-applied lengthwise along respective opposite screen edges such that deployment portions of the tape extend transversely beyond respective screen edges. The tape is a reinforced tape having a pressure sensitive adhesive (PSA) layer which bonds well to the screen material and to substantially any type of support surface surrounding a vent to be covered or to the vent itself. The screen mesh size must be no greater than ⅛ square or less (i.e., mesh number 8), and is preferably 1/16 square inch (mesh number 16), to assure that no embers can pass therethrough. Importantly, to function as a retrofit or aftermarket product, the screen material and tape are sufficiently malleable to be able to bend and fold as necessary to conform to substantially any existing vent installation configuration.

Also disclosed herein is a method for deploying an ember-blocking metal screen unit over a roof vent comprising pre-applying elongated strips of heavy duty pressure sensitive adhesive tape along opposite edges of the screen such that deployment portions of the tape strips overlap and transversely extend beyond respective screen edges, removing a protective release liner from one of the deployment portions and pressing that deployment portion into adhesive engagement with a support surface adjacent the roof vent, conforming the screen to the exterior configuration of the roof vent, removing a protective release layer from the other of the deployment portions and pressing that deployment portion into adhesive engagement with the support surface.

### BRIEF DESCRIPTION OF THE DRAWINGS

By way of example, a specific embodiment of the disclosed article of manufacture will now be described, with reference to the accompanying drawings, in which:

FIG. 1 is a perspective view from above of an ember-blocking vent screen;

FIG. 2 is a perspective view from below of the vent screen of FIG. 1 with a protective release liner of one of the tape strips partially removed;

FIG. 3A is a side view in elevation of the screen unit as shown in FIG. 1;

FIG. 3B is a side view in elevation of the screen unit as shown in FIG. 2:

FIG. 4A is a perspective view of common individual soffit vent having a curvilinear configuration;

FIG. 4B is a perspective view of another embodiment of the vent screen shown bent to conform to the curvilinear configuration of the vent of FIG. 4A;

FIG. 4C is a perspective view showing the vent screen of FIG. 4B deployed on and secured to the vent of FIG. 4A;

FIG. 5A is a perspective view of a common “whirlybird” type of roof vent;

FIG. 5B is a perspective view of another embodiment of the vent screen shown bent and cut and surrounding the vent of FIG. 5A in preparation for installation;

FIG. 5C is a perspective view showing the screen of FIG. 5B conformed to and installed on the vent of FIG. 5A:

FIG. 6A is a perspective view of a common continuous soffit vent;

FIG. 6B is a perspective view of yet another embodiment of the screen vent shown bent to match the contour of the vent of FIG. 6A; and

FIG. 6C is a perspective view showing the screen vent of FIG. 6B conformed to and installed on the vent of FIG. 6A:

### DETAILED DESCRIPTION

The article of manufacture and method of its use disclosed herein are described more fully below with reference to the accompanying drawings in which several exemplary embodiments are shown. It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

As used herein in connection with the disclosed screen product: “longitudinal” means the longest dimension of the screen section or, in the case of a square screen section, the dimension along which the tape strips extend; “transversely” and “widthwise” pertain to the dimension coplanar with and perpendicular to the longitudinal dimension; and “top” and “bottom” are used for convenience to refer to an arbitrary orientation of the screen and are not intended to otherwise limit the product described and claimed.

As used herein with respect to an ember, “diameter” means a straight line passing from side to side through the center of an ember.

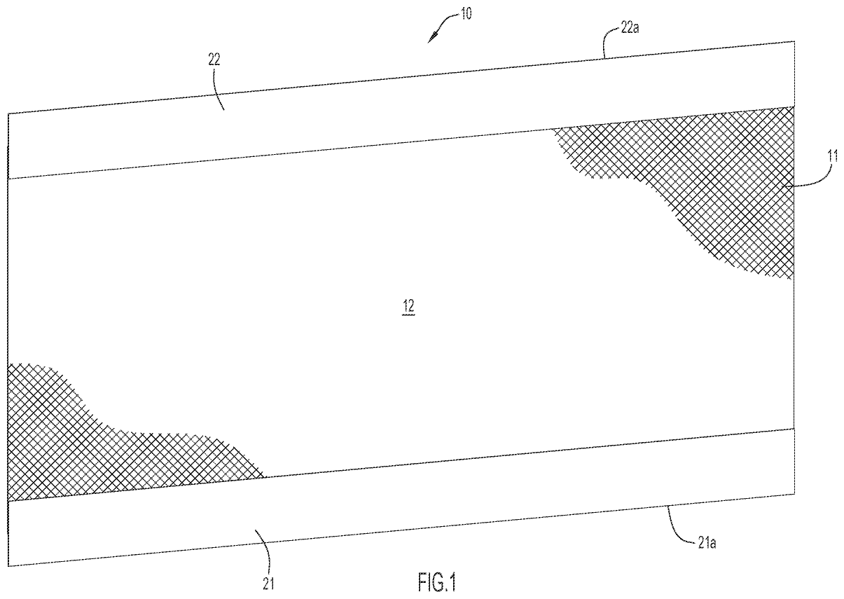

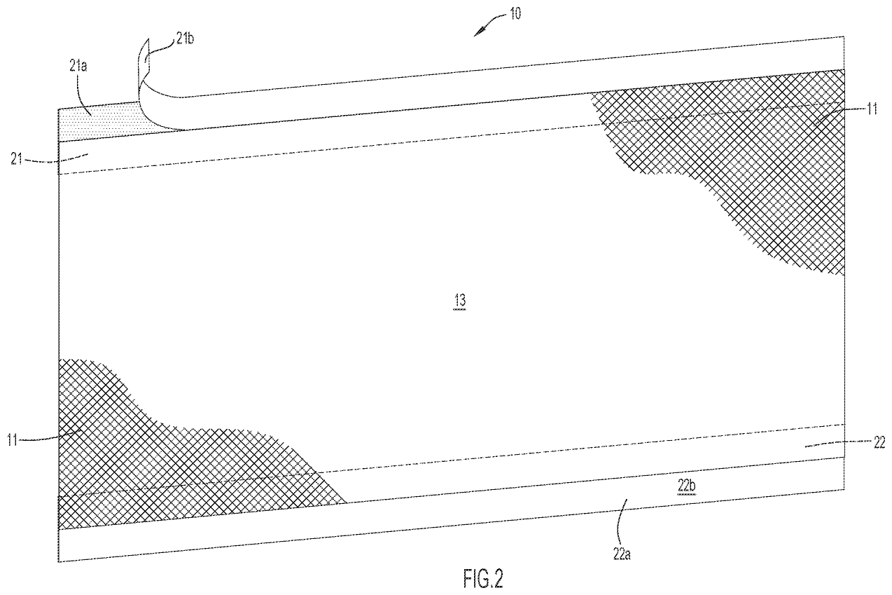

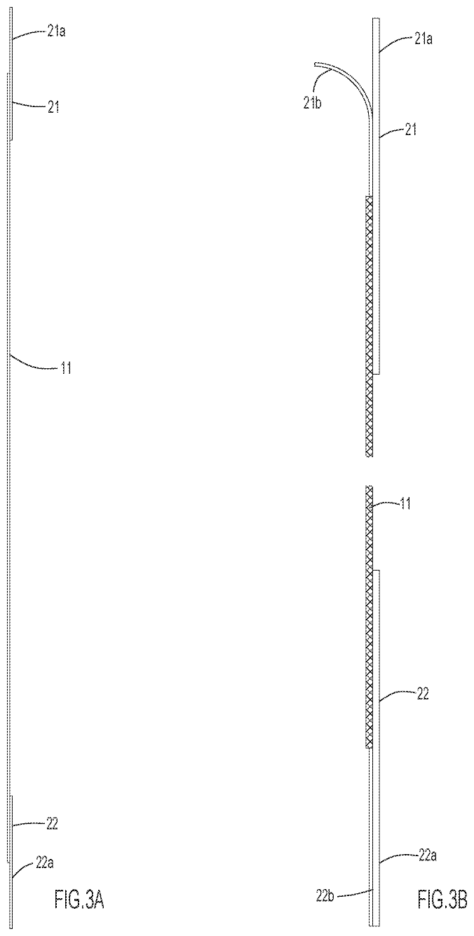

The present disclosure pertains to a rapidly deployable and reliable ember-blocking vent screen product that can function with soffit and gable roof vents of substantially any configuration. Referring specifically to FIGS. 1, 2, 3A and 3B, an embodiment of the vent screen 10 includes a substantially rectangular section of screen material 11 having a top surface 12 and a bottom surface 13, and two elongated strips 21, 22 of high strength edge tape that are coated on their undersides with a pressure sensitive adhesive (PSA) coating. The tape strips 21, 22 are adhesively secured on the top surface of 12 of screen section 11 along substantially the entire length of respective opposite longitudinal edges of the screen in an edge-overlapping manner such that elongated deployment portions 21a, 22a of the tape strips extend transversely beyond those edges. The adhesive-coated sides of the deployment portions 21a, 22a are covered with respective strips of protective release liner 21b, 22b that, prior to deployment of vent screen 10 on a vent, prevent unintended adhesive attachment of the vent screen to a surface.

To install the vent screen 10 over a roof vent (e.g., gable vent, soffit vent, etc.), the homeowner or other installer peels one protective release liner (e.g., liner 21b) away from its deployment portion 21a and presses that deployment portion in place on the surface of the gable or soffit adjacent the vent to be protected, thereby securing one edge of the vent screen to that surface. Once that edge is secured, the vent screen may be pulled taught over the vent surface if the vent surface is substantially planar; if the vent surface has a curved or angled contour, the installer presses and manipulates the vent screen section 11 against the vent to cause it to conform to the vent contour. In either case, once the screen section is positioned to cover the vent, protective release liner 22b is peeled away from deployment portion 22a and pressed in place on the surrounding surface to secure the opposite edge of the vent screen 10 in place. As will be appreciated, no special tools or expertise are required to quickly install the vent screen.

Speed of installation is an important aspect of vent screen 10. A home/building owner, upon becoming aware of the product disclosed herein, might think to purchase metal screening material and duct tape separately and attempt to cut screen shapes to match vent dimensions, measure and cut corresponding tape lengths to attach the screen segments to the vents, and otherwise assemble a flexible screen solution from component parts. However, wildfire emergencies frequently occur during periods of high wind conditions, expand rapidly and spew embers unpredictably over wide areas, making response times critical. Vent screen 10, with its preassembled screen and tape, PSA and release liner subassembly, is optimized to meet this time urgent installation challenge.

The PSA coating on tape strips 21, 22 is preferably able to bond to a wide variety of exterior building surfaces, including wood, metal and outdoor plastic siding, etc., and is capable of providing a seamless bond without those surfaces having to be cleaned beforehand. While it is recognized as common sense to wipe such surfaces clean before installing the vent screen, it is likely that the end user will be in an urgent rush to get the vent screen in place in the face of an approaching wildfire.

Additionally, the PSA layer must also be capable of bonding to the aluminum or steel material of vent screen 10. Specifically, since the screen material in contact with the tape is by definition a discontinuous surface of metal strands separated by voids, the selected adhesive must be able to bond securely to the metal strands and maintain that critical bond as the screen is flexed and manipulated during deployment or subjected to natural forces such as wind and other weather conditions when deployed. One example of a PSA that meets all of the aforesaid requirements is the transparent acrylic adhesive used by 3M® in its Aluminum Foil Tape 425 and Aluminum Foil Tape 427, the latter tape being preferred and particularly applicable for the disclosed embodiment because it is sold with a protective release liner attached, has long term durability, and withstands exposure to flame, heat and humidity.

The material used for the screen section 11 is metal, either stainless steel or, more preferably, aluminum because of its light weight. The screen openings must be sufficiently small to block passage therethrough of embers expected to be produced from wildfires in the geographic area of the home or other building to be protected by the vent screen 10. In this regard, ember size is a function of the burned material; it varies not only between types of plants (e.g., grass, trees, bushes, etc.), but also with different types of trees. In some geographic locations where the vegetation produces relatively large ember sizes, an 8-mesh screen (i.e., eight openings per inch) would be satisfactory and would block passage of embers having a minimum diameter of ⅛ inch or greater. However, to provide the best protection for substantially all conditions, a 16-mesh screen is preferred for the disclosed vent screen.

It is desirable that the screen wire be as thin as possible for several reasons, one of which is the weight of the vent screen which should be sufficiently low to assure that the vent screen can be easily held, handled and manipulated during installation on a vent. The low weight requirement for the screen is also important because the weight must not cause the deployment portions 21a, 22a of tape strips 21, 22 to become detached from the vent or the surrounding surface after installation, a factor that is particularly important for horizontal soffit vent installations where the downward force of the screen weight is unimpeded by any structure. Also important is that the thinner the screen wire, the greater is the malleability of the screen section 11 and the easier it is to conform the screen section to the surface of the protected vent. Lastly, thinner wire involves less metal for the screen section, and less metal results in lower cost. On the other hand, the screen wire must be sufficiently strong so as to not be damaged or broken when the vent screen section as manipulated to conform to the vent contour during installation. Wire that meets these stated specifications, and is therefore preferred for the disclosed embodiments, is 30-gauge or thinner aluminum wire.

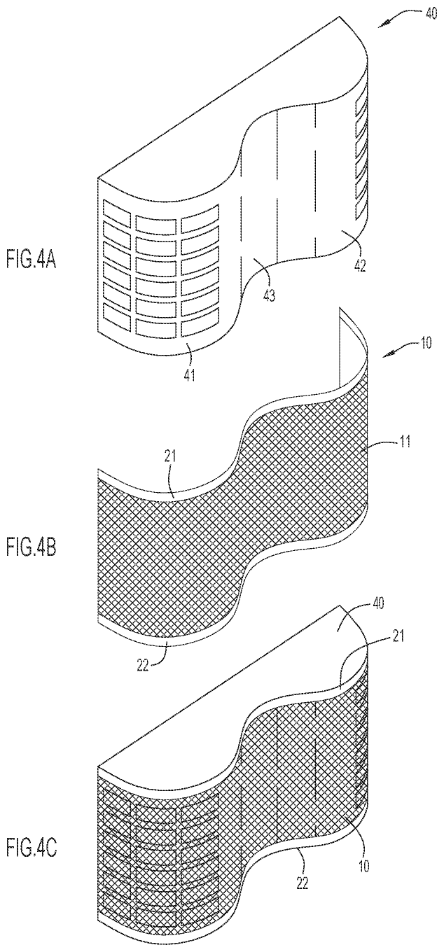

It will be understood that the flexible and readily conformable screen material, combined with the edge tape, can be folded, bent, or wrapped around or over substantially any vent system. For example, FIG. 4A illustrates a soffit vent 40 of the type disclosed in U.S. Pat. No. 5,692,955 (Meyer) having a curvilinear outer surface with two convex portions 41, 42 separated by a concave portion 43. Vent screen 10 is shown in FIG. 4B bent to match the contour of the outer surface of vent 40. In FIG. 4C the vent screen is shown deployed on vent 40 with tape strips 21, 22 secured to respective opposite longitudinal edges of the vent.

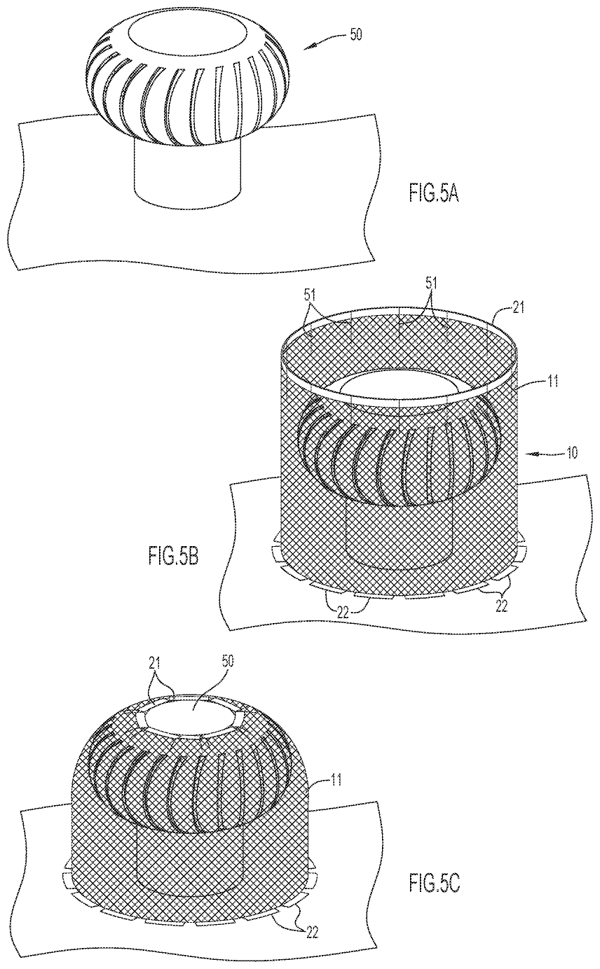

Another example of a roof vent is the whirlybird vent of the type disclosed in U.S. Pat. No. 4,608,792 (Gerber), shown herein as vent 50 in FIG. 5A, and which has wind-driven blades or scoops that actively direct outside air through the vent. In FIG. 5B a vent screen 10 is shown bent into a cylindrical configuration coaxially surrounding vent 50 in an initial stage of the installation. A series of short angularly spaced transversely extending slits 51 are cut into vent screen 10 from the upper end of the formed cylinder, to permit that end to be folded radially inward and downward to conform to the top of vent 50 as shown in FIG. 5C. Similarly, slits may be provided in edge tape 22 to enable it to spread out onto the support surface for vent 50.

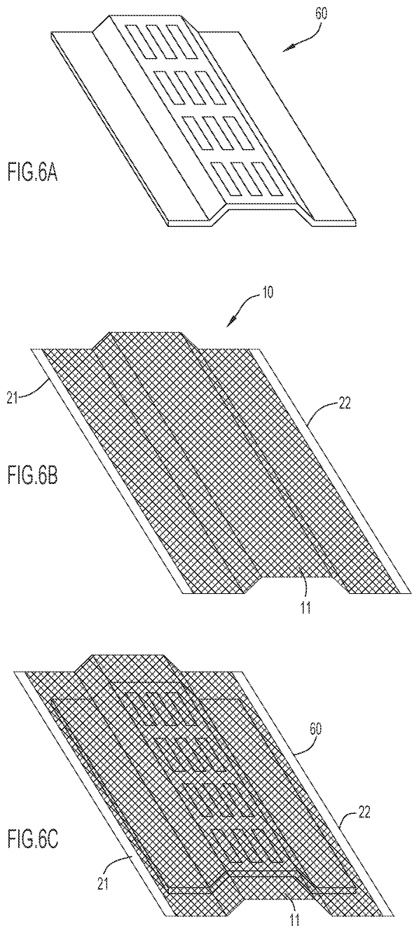

Roof vent 60, shown in FIG. 6A, is an example of a continuous vent type having an exposed surface contour comprising angularly related planar surfaces. A screen vent 10 is shown in FIG. 6B in which the screen section 11 has been bent to correspond to the surface contour of vent 60. In FIG. 6C the screen vent is shown deployed over the exposed surface of vent 60.

As noted, the screen vent units may be supplied in individual separate pre-cut sections or on rolls from which the units are cut to desired length. In either case, the use of the preferred aluminum screen material allows the homeowner to cut the screen with a simple scissors to accommodate most special vent shapes, lengths or assemblies. Moreover, although in the preferred embodiment the screen section 11 is rectangular, the screen section can be provided in any shape or configuration that is appropriate for the vent assembly that is to be covered. In the case of screen sections with curved or irregular peripheries, the edge tape may have to be provided in plural sections to cover an entire edge.

To provide some dimensional perspective without limiting the scope of the claimed subject matter, in one functional embodiment of vent screen 10 the unit was pre-cut to a length of 36″, the width of the unit, including the screen section and tape strips was 18″, and the screen material was 16 Mesh. It will be appreciated that these dimensions represent only one example and can vary considerably depending on the size and shape of the vent(s) to be covered,

The screen vents 10 may be provided with attachment tape also secured along the short edges of the screen section for complete perimeter sealing. Alternatively, and in the case of the screen being supplied in roll form, a supply of the edge tape with PSA and release liner may be included with the end product.

In the case of some custom or oversized vents, installation of the vent screen disclosed herein may require that several sections of the screen be installed with one or more of the tape mounting edges actually bonding to the outer surface of another adjacent section that has already been installed.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An ember-blocking vent screen comprising:
a screen section having first and second opposite edges and sufficient malleability to be readily manually manipulated to conform to a vent contour, said screen section having interstices sufficiently small to block passage of small diameter embers therethrough;
first and second strips of edge tape pre-assembled with said screen and secured along said first and second screen edges, respectively, in an edge-overlapping manner such that a deployment portion of each tape strip extends transversely beyond its screen section edge;
wherein each deployment portion includes a pressure sensitive adhesive layer covered with a release liner that is selectively removable from its deployment portion to permit the vent screen to be deployed on a vent.

2. The ember-blocking vent screen of claim 1 wherein the vent screen is made of aluminum.

3. The ember-blocking vent screen of claim 1 wherein said interstices are 1/16 square inches or less in area.

4. The ember-blocking vent screen of claim 1 wherein the edge tape is an aluminum foil tape, and wherein the pressure sensitive adhesive layer is a transparent acrylic adhesive.

5. The ember-blocking vent screen of claim 1 wherein the screen section is made from a readily malleable lightweight metal.

6. The ember-blocking vent screen of claim 1 wherein the screen section has a rectangular shape.

7. The ember-blocking vent screen of claim 1,
wherein the screen section is made from a readily malleable lightweight metal; and
wherein said interstices are 1/16 square inches or less in area.

8. The ember-blocking vent screen of claim 7 wherein the edge tape is an aluminum foil tape, and wherein the pressure sensitive adhesive layer is an acrylic adhesive.

9. A method for blocking passage of embers through a roof vent using an ember-blocking screen having elongated strips of heavy-duty pressure sensitive adhesive tape pre-attached thereto along respective opposite edges of the screen such that deployment portions of the tape strips overlap and transversely extend beyond respective screen edges, and respective protective release liners cover the pressure sensitive adhesive on the deployment portions, said method comprising:
removing the protective release liner from one of the deployment portions and pressing that deployment portion into adhesive engagement with a support surface adjacent the roof vent;
pulling the screen taut over the roof vent transversely of said one deployment portion and conforming the screen to the exterior configuration of the roof vent; and
removing the protective release layer from the other of the deployment portions and pressing the other deployment portion into adhesive engagement with the support surface at a location transversely opposite said one deployment portion.

10. The method of claim 9 further comprising providing said screen as a readily malleable lightweight metal with said interstices 1/16 square inches or less in area.

11. A method for deploying an ember-blocking vent screen over a roof vent comprising:
attaching elongated strips of heavy-duty pressure sensitive adhesive tape along opposite edges of the screen such that deployment portions of the tape strips overlap and transversely extend beyond respective screen edges;
removing a protective release liner from one of the deployment portions and pressing that deployment portion into adhesive engagement with a support surface adjacent the roof vent;
conforming the screen to the exterior configuration of the roof vent; and
removing a protective release layer from the other of the deployment portions and pressing the other deployment portion into adhesive engagement with the support surface.

12. The method of claim 9 further comprising providing said screen as a readily malleable lightweight metal with said interstices 1/16 square inches or less in area.
